(19) United States
(12) Patent Application Publication
(10) Pub. No.: US 2007/0002870 A1
(43) Pub. Date: Jan. 4, 2007

(54) Padding time-slice slots using variable delta-T

(75) Inventors: Harri J. Pekonen, Raisio (FI); Jussi Vesma, Turku (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 11/169,680

(22) Filed: Jun. 30, 2005

(51) Int. Cl. H04L 12/56; H04B 7/212

(52) U.S. Cl. 370/395.42; 370/442

(57) ABSTRACT

Provided are apparatuses and methods for transmitting real-time service data in a digital broadcast network (e.g., DVB-H network), where gaps in the transmission are filled with non-real-time service data. Two types of service data are received as packets to be formed into time-slice bursts. Real-time service data, which typically varies in bit rate (e.g., streaming video), leaves gaps when capacity is reserved for it. These gaps are filled with non-real-time service data (e.g., file download) when forming time-slice bursts.

### FIELD OF THE INVENTION

The invention relates generally to digital broadcast transmission systems. More specifically, the invention provides for using excess digital broadcast bandwidth more efficiently.

### BACKGROUND OF THE INVENTION

Digital broadband broadcast networks enable end users to receive digital content including video, audio, data, and so forth. Using a mobile terminal, a user may receive digital content over a wireless digital broadcast network. Digital content can be transmitted wirelessly using a fixed data rate, such as provided by the MPEG-TS (Moving Pictures Experts Group Transport Stream) standard. When transmitting time-sensitive digital content which streams at a variable rate (e.g., compressed video or audio), the use of a fixed rate transmission system often results in gaps where no content is sent. Such gaps may be filled with null packets or other useless filler, resulting in the inefficient transmission of content. In a situation where a mobile terminal is attempting to conserve power by minimizing radio time, such inefficient transmission can result in power being needlessly wasted.

Methods and systems are needed to enable more efficient transmissions in wireless digital broadcast networks.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

Aspects of a first embodiment of the invention provide for padding data for interleaving in a manner which maximizes interleaving length. Null or other padding packets may be multiplexed into an incomplete frame of data, positioning the padding packets so as to maximize interleaving length.

Aspects of a second embodiment of the invention provide for padding time-slice bursts having available capacity with useful data packets. Time-slice bursts of a fixed bit rate and duration filled with real-time service data (e.g., streaming video) may leave available capacity. Less time-sensitive non-real-time service data (e.g., a file download) may be used to fill in individual bursts so as to maximize the amount of useful data sent in a given period of time.

Aspects of a third embodiment of the invention provide for padding time-slice frames having available capacity with related useful data packets. Non-real-time service data from the same service is used to fill all the available bursts of a particular frame. Receivers may view the entire frame as a single burst for receiving the particular non-real-time service.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system in which one or more illustrative embodiments of the invention may be implemented.

FIG. 2 illustrates a suitable digital broadcast transmitter in which one or more illustrative embodiments of the invention may be implemented.

FIG. 3 illustrates a suitable mobile terminal in which one or more illustrative embodiments of the invention may be implemented.

FIG. 4 depicts an example of a Tisle frame, slot, and subslot structure according to one or more illustrative embodiments of the invention.

FIG. 5 depicts an example of Tisle subslot numbering according to one or more illustrative embodiments of the invention

FIG. 6 depicts an example of the usage of transport stream configuration parameters according to one or more illustrative embodiments of the invention.

FIG. 7 illustrates an example of mapping elementary streams into the Tisle frame, slot and subslot structure according to one or more illustrative embodiments of the invention.

FIG. 8 illustrates a time slicing block in detail according to one or more illustrative embodiments of the invention.

FIG. 9 illustrates a transport stream generation/multiplexing block in detail according to one or more illustrative embodiments of the invention.

FIG. 10 illustrates adding null packets to fill a Tisle slot according to one or more illustrative embodiments of the invention.

FIG. 11 illustrates adding null packets to fill a divided Tisle slot according to one or more illustrative embodiments of the invention.

FIGS. 12-13 illustrate the transmission of data for real-time and non-real-time services.

FIG. 14 illustrates using non-real-time services data to pad the unused capacity from real-time services according to one or more illustrative embodiments of the invention.

FIG. 15 depicts using non-real-time service data for one service to pad the unused portions of a Tisle frame according to one or more illustrative embodiments of the invention.

FIGS. 16-17 depict using non-real-time service data to pad the unused portions of Tisle slots according to one or more illustrative embodiments of the invention.

FIG. 18 is a flowchart illustrating a method for maximizing interleaving length for MPE-FEC according to one or more illustrative embodiments of the invention.

FIG. 19 is a flowchart illustrating a method for padding real-time service Tisle slots with non-real-time service packets according to one or more illustrative embodiments of the invention.

FIG. 20 is a flowchart illustrating a method for padding real-time service Tisle frames with non-real-time service packets according to one or more illustrative embodiments of the invention.

FIG. 21 illustrates a suitable digital broadcast transmitter in which one or more illustrative embodiments of the invention may be implemented.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

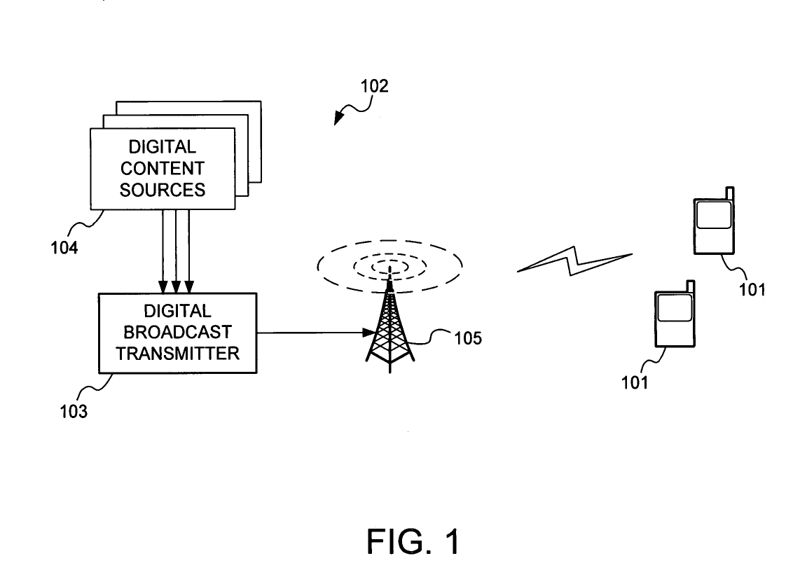

FIG. 1 illustrates a suitable digital broadband broadcast system 102 in which one or more illustrative embodiments of the invention may be implemented. Systems such as the one illustrated here may utilize a digital broadband broadcast technology, for example Digital Video Broadcast—Handheld (DVB-H). Examples of other digital broadcast standards which digital broadband broadcast system 102 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Forward Link Only (FLO), Digital Audio Broadcasting (DAB), and Digital Radio Mondiale (DRM). Other digital broadcasting standards and techniques, now known or later developed, may also be used.

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission implements) for wireless transmission. Ultimately, mobile terminals 101 may selectively receive and consume digital content originating with digital content sources 104.

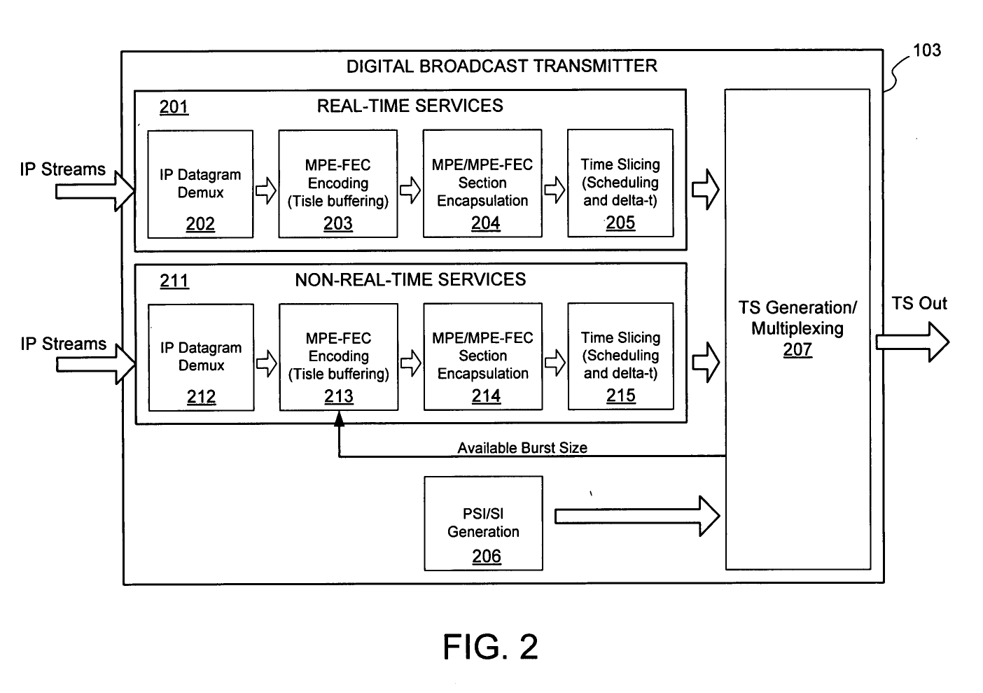

FIG. 2 illustrates a suitable digital broadcast transmitter 103 in which one or more illustrative embodiments of the invention may be implemented. Such a device may be referred to as an IP encapsulator. The functional blocks depicted in FIG. 2 present merely one possible embodiment of digital broadcast transmitter 103. Other embodiments may separate or rearrange functionality depicted. IP streams delivering content to digital broadcast transmitter 103 include both real-time services and non-real-time services. Real-time services may include content which should be delivered in a time-sensitive fashion. Non-real-time services may include content which is time-insensitive, or at least less time-sensitive. A service represents one or more IP streams carrying related content (e.g., a video stream coupled with its associated audio stream). Real-time services may include video or audio, or any such streams of content which rely on timely and continuous delivery. Non-real-time services may include anything for which timely and continuous delivery is less important, e.g., the downloading of a data file. IP streams for different types of services may be separated into two or more parallel pipelines 201, 211 within transmitter 103 for separate processing. Alternative embodiments may allow the scheduled sharing of different types of IP streams within the same pipeline.

Within any pipeline, the IP datagram demux 202, 212 block filters out desired IP streams and divides those into elementary streams. Each elementary stream is written to a separate output. One elementary stream can contain one or more IP streams. The IP streams for each elementary stream are delivered to the Multi-Protocol Encapsulation—Forward Error Correction (MPE-FEC) encoding 203, 213 block, where they are written into an application data table. Each elementary stream is written into its own table. Once the application data table is full (or if the delta-t period has passed) the encoding block acts. If MPE-FEC is enabled, the block calculates Reed Solomon (RS) parity bytes and inserts them into an RS data table. Both data tables together, forming one MPE-FEC frame, are forwarded to the next functional block. If MPE-FEC is not enabled, then the block does not perform RS calculations, and merely buffers the IP streams for time-slice forming.

In DVB-H transmission systems, by sharing memory between the time slice buffer and the MPE-FEC RS code, a memory savings (up to 2048 kbits) is achieved. Hence one Tisle, or time slice, burst is the same as one MPE-FEC frame. The word Tisle is intended to refer to time slicing of digital content as used, for example, by the DVB-H standard. A Tisle slot represents one time-sliced burst of digital content. A Tisle frame represents a collection of Tisle slots which repeat from frame to frame.

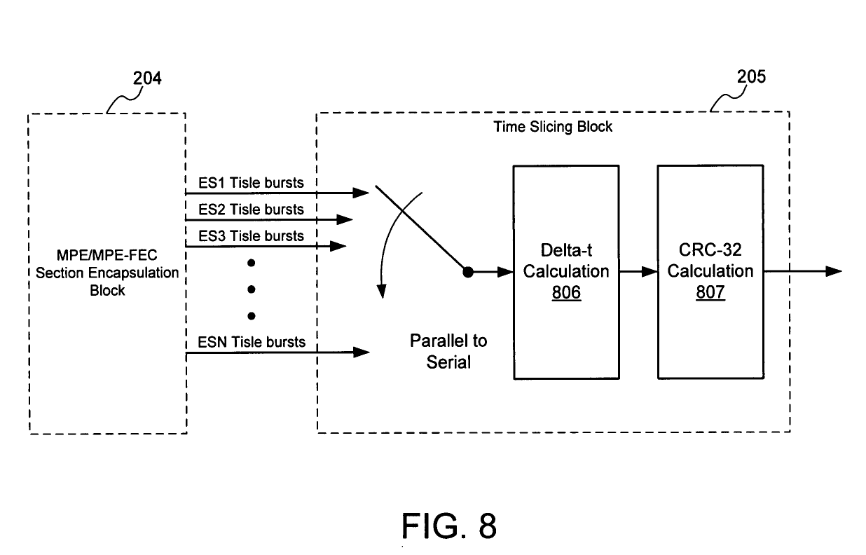

The MPE/MPE-FEC section encapsulation 204, 214 block encapsulates the payload from the previous block into a section and forms a section header. The payload is an IP datagram for a MPE section, and an RS column for a MPE-FEC section. All real-time parameters needed for each section, except for delta-t (explained below) and CRC-32, are here inserted. Section header values, including address, table_boundary, and frame_boundary are inserted into the MPE and MPE-FEC sections. Additionally, MPE-FEC-specific header values are inserted into the section, including padding_columns, last_section_number, and section_number. The sections are then forwarded to the time slicing 205, 215 block, where delta-t is calculated and inserted into section headers. Time slicing 205, 215 also calculates Cyclic Redundancy Check (CRC-32) values which are inserted into the sections as well. For a closer look at the functioning of the time slicing block, see FIG. 8 and related description.

Time slicing involves the transmitting of content in high-bandwidth bursts rather than in lower-bandwidth constant streams. As such, receivers of transmissions should be able to know when the next burst will be arriving, and hence delta-t is calculated to inform receivers when the following burst is to be expected. In this fashion, low power receivers are able to receive content in bursts and power down their radios in between transmissions. Differing content can be scheduled in interspersed intervals, allowing a receiver to turn on and off its radio only when content of interest is expected. A Tisle frame represents a series of time-sliced bursts sent in sequence. A Tisle slot is the spot that one burst takes within a Tisle frame. Content transmitted within a particular slot of a first frame will be broadcast in the same slot in a subsequent second frame.

The Transport Stream (TS) generation & multiplexing 207 block fragments incoming time-sliced sections into the payload of TS packet(s) and generates a header for each TS packet. The Moving Pictures Experts Group Transport Stream (MPEG TS) standard may be used to form the TS packets. The functional block also integrates sections from real-time services and non-real-time services. Finally, the time sliced sections and program specific information and signaling information (PSI/SI) from the PSI/SI generation 206 block are multiplexed into one output TS having a fixed data rate.

Certain embodiments of the invention may incorporate the use of available burst size information from the TS generation & multiplexing 207 block into the MPE-FEC encoding process for non-real-time services. Such use is covered in more detail below.

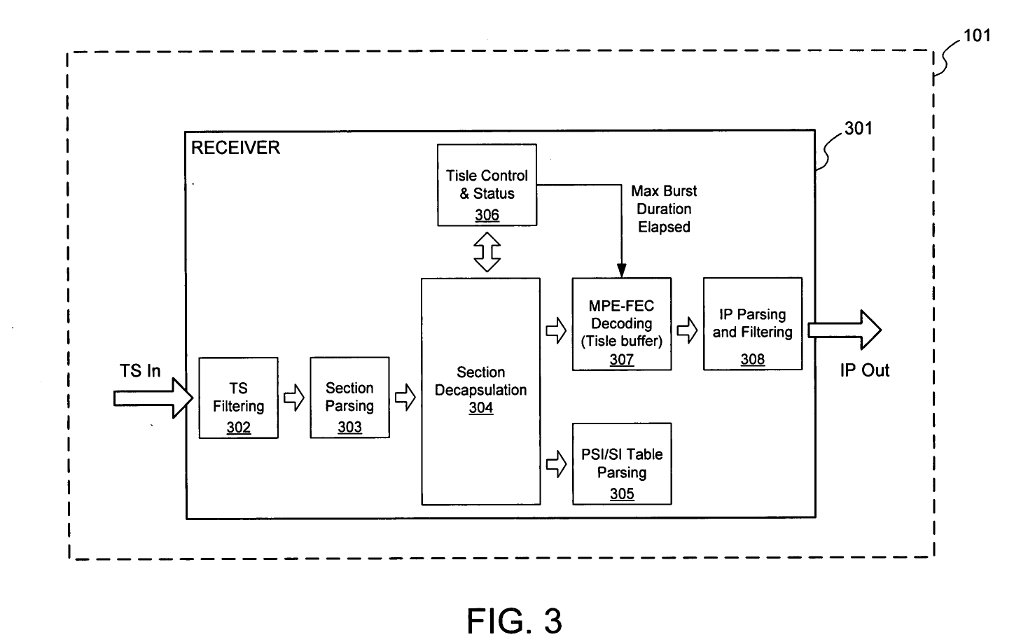

FIG. 3 illustrates a suitable mobile terminal 101 in which one or more illustrative embodiments of the invention may be implemented. Although one particular design is provided, functional blocks provided here may be combined, rearranged, separated, or even skipped.

An incoming signal is received by mobile terminal 101 and passed to receiver 301 as a transport stream (TS). The TS filtering block 302 receives the incoming TS in its entirety and, according to program identifiers (PIDs) assigned to TS packets, passes on only those TS packets belonging to desired content or elementary stream(s). Section parsing 303 decapsulates the payload of the TS packets and re-forms sections. The section decapsulation 304 block extracts real-time parameters and the payloads of each section. Based on the type of section (MPE/MPE-FEC or PSI/SI), it sends the section payloads and some real-time parameters to either the MPE/MPE-FEC decoding 307 or PSI/SI table parsing 305 blocks. Real-time parameters may also be sent to the Tisle control and status 306 block.

The Tisle control and status 306 block is responsible for switching off receiver 301 after a particular burst is fully received, and again switching the receiver back on before the next burst is about to be received. It also signals the MPE/MPE-FEC decoding 307 block when the time of maximum burst duration has elapsed. This signaling may be needed so that the decoding block knows to start decoding in the case where the tail end of a burst is lost.

MPE/MPE-FEC decoding 307 block writes section payloads into an MPE-FEC frame according to address information (as determined from the real-time parameters) and decodes the whole frame row by row. The decoder can be either an erasure or non-erasure decoder. Erasure info can be obtained from the section CRC-32 or, if the erroneous TS packets are passed forward, from the transport error indicator located in the header of the TS packet. If the MPE-FEC is not used, then this block only works as a time-slicing buffer storing one burst at a time.

IP parsing and filtering 308 block receives a whole MPE-FEC frame (or time-sliced burst). It goes through the corrected data areas in the frame to detect IP datagrams that were originally erroneous but were corrected by the decoder. It then only passes on IP datagrams having a desired IP address. PSI/SI table parsing 305 parses PSI/SI tables from among the sections and delivers signaling information to other portions of mobile terminal 101.

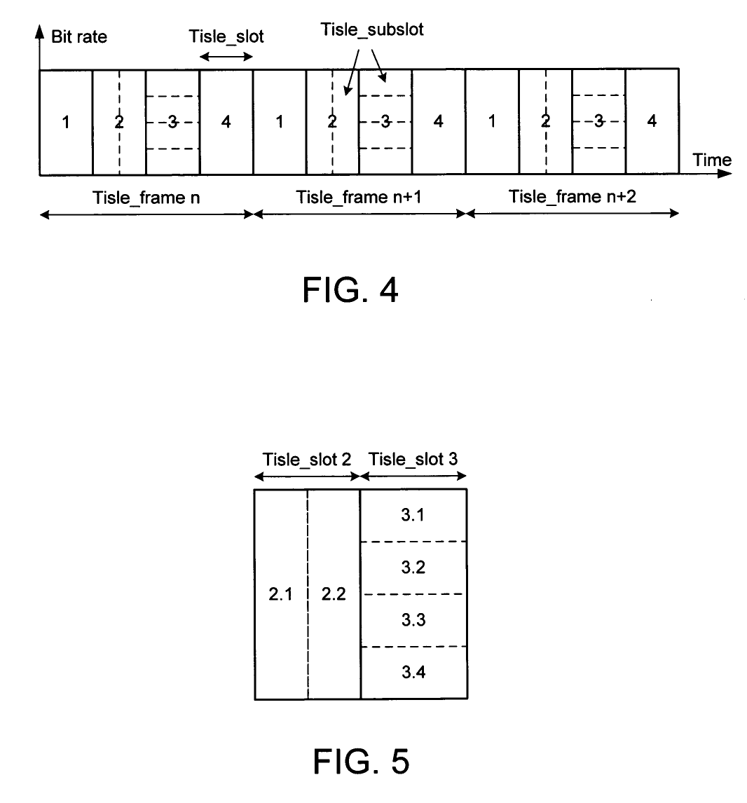

FIG. 4 depicts a graph illustrating an example of a Tisle frame, slot, and subslot structure according to one or more illustrative embodiments of the invention. The graph is of bit rate over time, showing which Tisle slots are bursting at which time. An elementary stream can appear in only one slot inside the Tisle frame, and it must use the same slot from frame to frame. So if, for example, a particular video program is provided using a particular elementary stream which appears in Tisle_slot 2, the elementary stream will always appear in the second slot of each frame. Because of this, if a receiver is only interested in the particular program, it needs only to power up and receive the second slot of each frame, powering down for the remainder of each frame.

A Tisle slot can be further divided into a number of subslots, as shown in FIG. 4. A slot divided as shown can be shared between multiple elementary streams. Subslots can be either horizontal or vertical and can be numbered as shown in FIG. 5. When using vertical division, a particular elementary stream uses the full bit rate of the transmission over a portion of the slot's time. This may lead to power savings by shortening the duration that a radio needs to power up to receive a particular elementary stream. However, when using MPE-FEC for error correction, vertical division shortens the interleaving length used, reducing the gain achieved by MPE-FEC. When using horizontal division, a particular elementary stream uses only a portion of the full bit rate, but uses it for the full duration of the Tisle slot. Here, power savings is reduced, but interleaving length is longer, increasing the gain achieved by MPE-FEC.

Configuring a transmitter to send elementary streams using the Tisle structures discussed above may require roughly three steps. First, transport stream (TS) specific configuration parameters and frame and slot structures are defined. Second, elementary streams are mapped into the frame and slot structures. Finally, elementary stream specific configuration parameters are determined, e.g., MPE-FEC parameters.

These steps are by no means the only method for configuring a transmitter, but simply serve as an example of how to complete the task.

In configuring a transport stream, the following parameters may be used:

TABLE 1
Transport Stream Configuration Parameters

| Name | Description |
|---|---|
| TS_bit_rate | Bit rate in Mbit/s in TS level. |
| TS_bit_rate_Tisle | TS bit rate reserved for time sliced elementary |
| | streams (peak bit rate). |
| TS_bit_rate_DVB_T | TS bit rate reserved for DVB-T services. |
| TS_bit_rate_SI_PSI | TS bit rate reserved for PSI/SI tables. |
| Tisle_frame_duration | The duration of the Tisle frame in seconds. |
| Tisle_slots_in_frame | The number of Tisle slots in a Tisle frame. |
| Tisle_slot_division | Slot specific. Defines the divisions of slots into |
| | subslots. |
| Tisle_slot_mux_mode | Slot specific. Defines whether a particular slot |
| | is horizontally or vertically divided. |

The first four parameters define the TS level bit rates for different types of elementary streams as well as the whole TS stream. The remaining parameters define the time slicing frame and slot structures. TS_bit_rate is determined based on chosen radio modulation parameters (e.g., modulation, code rate, and guard interval). TS_bit_rate_SI_PSI is determined such that the transmission intervals of PSI/SI tables do not exceed the maximum time specified in DVB standards.

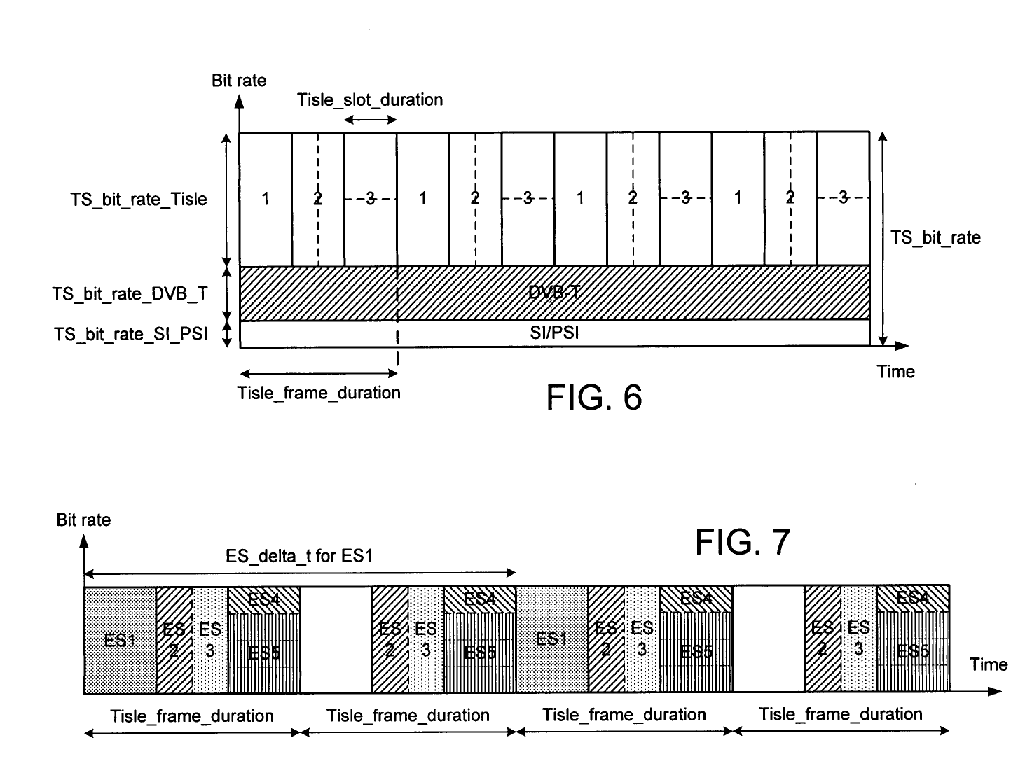

FIG. 6 depicts an example of the usage of transport stream configuration parameters.

In this example, the TS bit rate has been divided between time sliced (Tisle), DVB-T, and SI/PSI streams as defined by their corresponding parameters. Furthermore, there are three slots in one Tisle frame: Tisle_slots_in_frame=3. Tisle slots 2 and 3 are vertically and horizontally divided respectively, both into two subslots: Tisle_slot_division=[1 2 2] and Tisle_slot_mux_mode=[NotUsed vertical horizontal]. Using the bracketed notation identifies slot specific parameters for each of the respective slots. So “Tisle_slot_division=[1 2 2]” provides the slot division value for each of the slots. Slot 1 has 1 subdivision (effectively no divisions) and Slots 2 and 3 each have 2 subdivisions. Since, Tisle slot 1 is not divided, Tisle_slot_mux_mode is ignored for this slot.

Elementary streams may be mapped into the Tisle frame, slot, and subslot structure using the following parameters:

TABLE 2
Elementary Stream Mapping Parameters

| Name | Description |
|---|---|
| ES_slot_number | Defines the slot number used for an elementary |
| | stream. |
| ES_subslot_number | Defines the subslot number(s) for an elementary |
| | stream. |
| ES_repeat_period | An elementary stream can have a burst in every |
| | Nth Tisle |
| | frame, where ES_repeat_period = N. |
| ES_delta_t | Specifies the delta-t for the particular elementary |
| | stream. |
| | Derived using Tisle_frame_duration * |
| | ES_repeat_period. |

The bursts of an elementary stream in different Tisle frames always appear in the same slot as determined by the ES_slot_number and in the same subslot(s) as determined by the ES_subslot_number. ES_repeat_period determines the number of frames between subsequent bursts for a particular elementary stream, and ES_delta_t is derived using that value.

FIG. 7 illustrates an example of mapping elementary streams into the Tisle frame, slot and subslot structure. In this example, there are three slots per frame (Tisle_slots_in_frame=3), slot 2 is divided into two subslots vertically, and slot 3 is divided into four subslots horizontally (Tisle_slot_division=[1 2 4] and Tisle_slot_mux_mode=[NotUsed vertical horizontal]). The elementary stream mapping parameters for each of the elementary streams in FIG. 7 are provided below:

TABLE 3
Example of Elementary Stream Mapping Parameters

| Parameter | ES1 | ES2 | ES3 | ES4 | ES5 |
|---|---|---|---|---|---|
| ES_slot_number | 1 | 2 | 2 | 3 | 3 |
| ES_subslot_number | 1 | 1 | 2 | 1 | 2, 3, 4 |
| ES_repeat_period | 2 | 1 | 1 | 1 | 1 |
| ES_delta_t/ | 2 | 1 | 1 | 1 | 1 |
| Tisle_frame_duration | | | | | |

Of interest in the example of FIG. 7 and the above table, ES4 and ES5 share Tisle slot 3. ES4 occupies only one subslot (1), whereas ES5 occupies 3 subslots (2, 3, 4) from the same slot. Perhaps because it is a lower bandwidth, ES1 repeats every second frame, and therefore, delta-t for ES1 is twice the Tisle_frame_duration.

Each elementary stream may be specifically configured using the following parameters:

TABLE 4
Elementary Stream Specific Configuration Parameters

| Name | Description |
|---|---|
| ES_PID | Program identifier (PID) for an elementary |
| | stream. |
| ES_IP_address | Defines IP addresses for an elementary |
| | stream. |
| time_slicing | Indicates whether time slicing is used for |
| | an elementary stream. |
| mpe_fec | Indicates whether MPE-FEC is used for an |
| | elementary stream. |
| Tisle_burst_size | The maximum size of a Tisle burst for an |
| | elementary stream. |
| FEC_padding_columns | Minimum number of full padding columns |
| | in the application data table. This is the static |
| | portion of the padding. Actual number of |
| | padding columns in an MPE- FEC frame |
| | may be greater than this value. |
| FEC_punctured_columns | The number of punctured RS columns. |

Set forth above is only one possible method for mapping elementary streams into a Tisle frame, slot and subslot structure.

Returning to digital broadcast transmitter 102, FIG. 8 illustrates a time slicing 205 block in greater detail according to one or more embodiments of the invention. The block reads parallel Tisle bursts or MPE-FEC frames which consist of MPE and MPE-FEC sections, making the conversion from parallel to serial. Next, time slicing 205 block calculates and inserts delta-t values for the sections in the bursts and finally calculates and inserts the CRC-32 checksum. When the duration of Tisle slots and frames are fixed, the calculation of delta-t simply requires knowing the Tisle frame duration. However, when the duration of slots and frames vary, the calculation of delta-t (the amount of time until the same slot in the next frame will be transmitted) is more complicated, and requires that an additional frame of data be buffered. The output from this block is a serial stream of Tisle bursts.

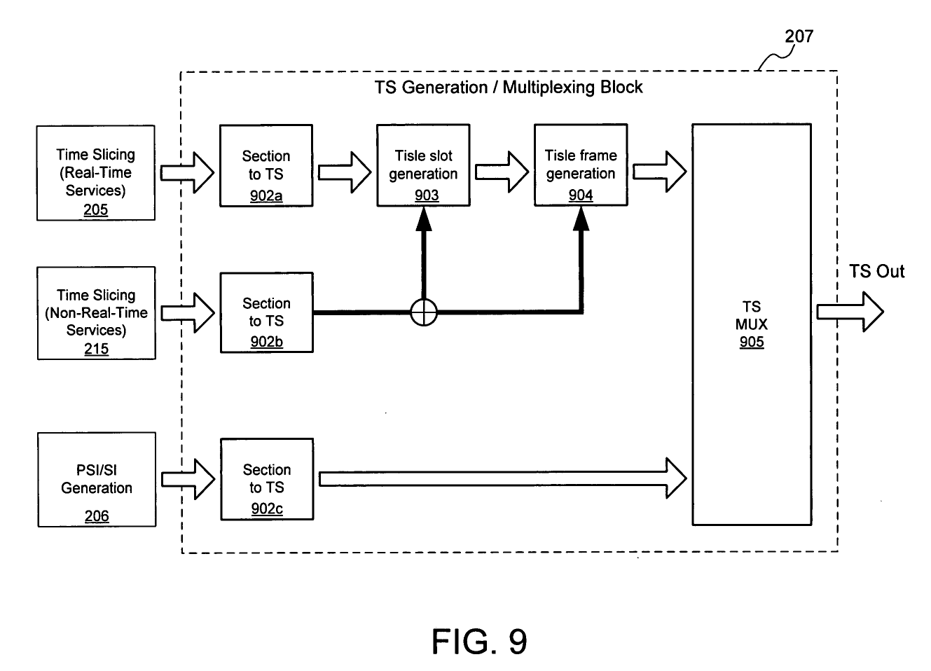

FIG. 9 illustrates a transport stream (TS) generation/multiplexing 207 block in greater detail according to one or more embodiments of the invention. The block reads the serial streams of Tisle bursts from both time slicing 205, 215 blocks, and PSI/SI sections from PSI/SI generation 206 blocks and fragments them into TS packets in section to TS 902a, 902b, 902c blocks. Section to TS 902a, 902b, 902c blocks also insert an appropriate program identifier (PID) when forming TS packets. For time-sliced services (real-time services), the block generates a slot and frame structure in their respective blocks 904, 905.

At this point, a transmitter may be able to proceed in one of several ways with regard to filling unused capacity in Tisle slots and frames. For real-time services (e.g., video or audio), the bit rate of transmission over any period of time is not usually constant. In such situations, a maximum bit rate may be allocated or reserved for the time-sensitive service, but it may not always be used. As such, when time sliced bursts are formed into Tisle slots and frames, they may not use all of the available bandwidth. In such situations, the empty space may be filled with null TS packets in order to maintain the constant bit rate needed for TS transmission. Null packets may be recognized by receivers as being useless filler and be discarded. A transmitter may also use TS packets formed for non-real-time services to fill in the gaps, optimizing throughput. These useful TS packets may be inserted as slots are formed or may be inserted as frames are formed. Each of these methods is discussed in more detail below.

In DVB-H systems, much of the gain associated with MPE-FEC coding comes from a greater interleaving length. The interleaving length (i.e. the time span of one whole MPE-FEC frame) is the same as the Tisle burst duration. This duration may be found in the range of 100 ms-400 ms. This means that the interleaving gain (or time diversity) can be achieved also when mobile terminal 101 is moving at low to moderate speeds (i.e. when the coherence time of the channel is long).

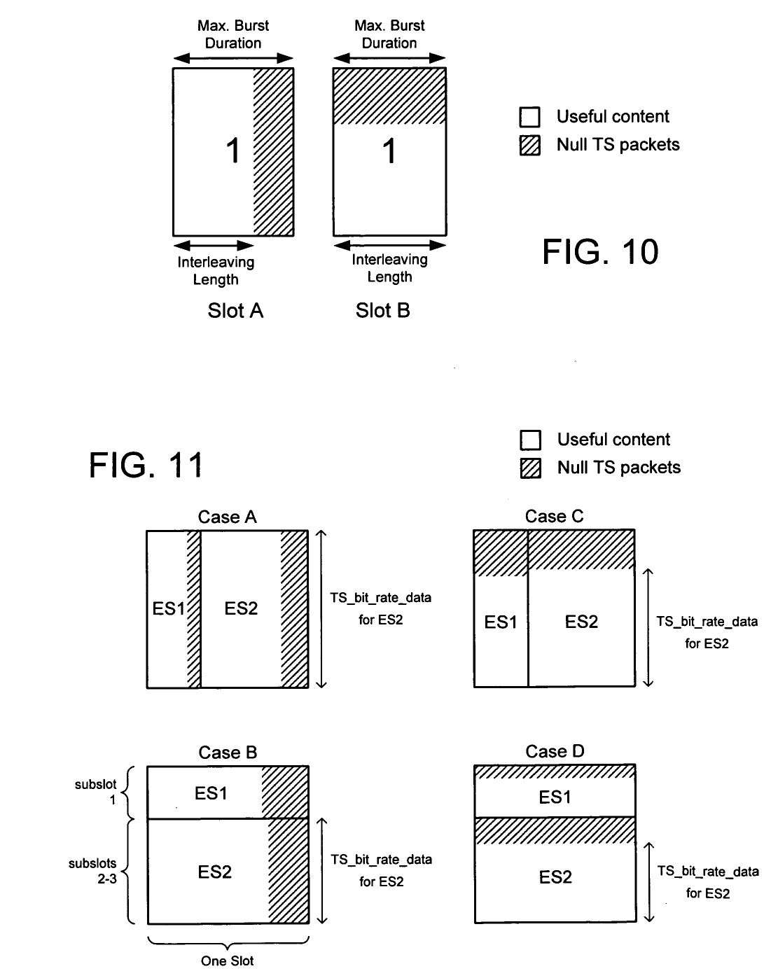

FIG. 10 illustrates adding null TS packets to fill a Tisle slot according to one or more embodiments of the invention. In the figure, slot A and slot B both contain the same amount of data for elementary stream 1. Conventionally, when the data of elementary stream 1 does not fill the maximum burst duration (or MPE-FEC frame), null TS packets are entered after the data, as in slot A. Problems may arise in placing the null TS packets after the useful data, as doing so effectively shortens the interleaving length, reducing the gain of MPE-FEC coding. When Tisle bursts contain real-time services whose bit rate naturally varies, then the gain associated with MPE-FEC will vary from burst to burst. Ultimately, this variability in the quality of signal received can be difficult to work with. Since fixed burst sizes are reserved for real-time services (e.g., streaming video) with naturally varying bit rates, there will almost always be an insertion of null TS packets and a subsequent reduction in interleaving length and MPE-FEC gain.

Slot B shows the multiplexing of null TS packets together with data packets over the maximum burst duration, rather than packing the null packets at the end as in slot A. In this fashion, the duration of the data burst is always stretched to the maximum value allowing fixed maximum interleaving length. In this fashion, the interleaving length remains constant, and the quality of the signal is less likely to vary between bursts.

FIG. 11 illustrates adding null TS packets to fill a divided Tisle slot according to one or more embodiments of the invention. Cases A and B display the conventional way of adding null TS packets to subslots carrying elementary streams which do not fill their respective subslots. In both cases (Case A divided vertically, Case B divided horizontally), null TS packets are added after both elementary stream 1 and elementary stream 2. According to one or more aspects of the invention, cases C and D depict the multiplexing of null packets throughout a vertically and horizontally divided slot respectively. In these latter cases, the longer interleaving length is assured, although bit rate data values for the elementary streams may now vary from burst to burst.

It should be noted that available space for data in unfilled Tisle bursts need not necessarily be filled with useless null TS packets. If other useful data is available, this information can be multiplexed in with ES1 and ES2 as well.

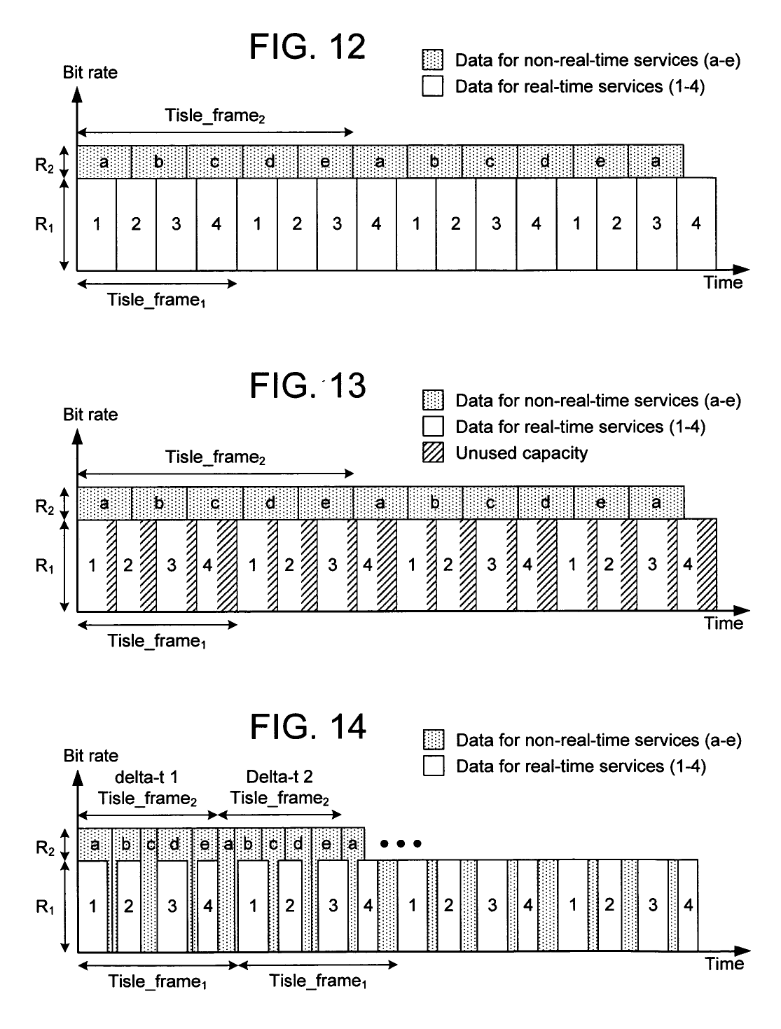

FIG. 12 illustrates the transmission of data for real-time and non-real-time services over time. Here, real-time services (a-e) and non-real-time services (1-4) are each reserved a portion of the available bit rate, and burst sizes for each set of services are fixed. Since multiple pipelines are used for the different types of services, Tisle frames and slots may have a different duration between the two types of services. Here, the real-time services have a bit rate of R₁ and a Tisle period of Tisle_frame₁, whereas non-real-time services have bit rate R₂ and Tisle period of Tisle_frame₂. Any unused capacity is not shown in this figure.

FIG. 13 once again illustrates the transmission of data for real-time and non-real-time services over time. Here, however, there is padded/unused capacity among real time services 1 to 4. Conventionally, this unused capacity is filled with null TS packets. Burst sizes here remain fixed. FIG. 14 illustrates using data from non-real-time services to pad the unused capacity from real-time services according to one or more embodiments of the invention. FIG. 9 also illustrates where in the real-time services branch that non-real-time service TS packets can be added, specifically in the Tisle slot generation 903 block.

As FIG. 14 shows, the reserved bit rates R₁ and R₂ are maintained, ensuring that non-real-time services always are transmitted, even when there is no unused capacity. When available, data from non-real-time services is used to pad the unused capacity in the real-time services. Non-real-time service data sent as real-time filler need not differ from data sent as a part of the reserved bit rate. As a result of using non-real-time service data in this fashion, the available capacity is used more efficiently, with fewer or no null TS packets having to be sent. Even if no unused capacity existed in real-time services 1-4, non-real-time service data is still delivered using its reserved portion of the available bit rate, R₂. Non-real-time service data (e.g., a file download) may now be delivered more quickly.

It should be noted that non-real-time delta-t value may vary from frame to frame. Because of this, non-real-time data for a whole Tisle period will be buffered before the transmission of the frame in order to calculate delta-t for the next frame. When frames and slots have a fixed duration, additional frames need not be buffered in order to determine the next delta-t. As such, using non-real-time data for this purpose is helpful, since it does not have the time-sensitivity of real-time services.

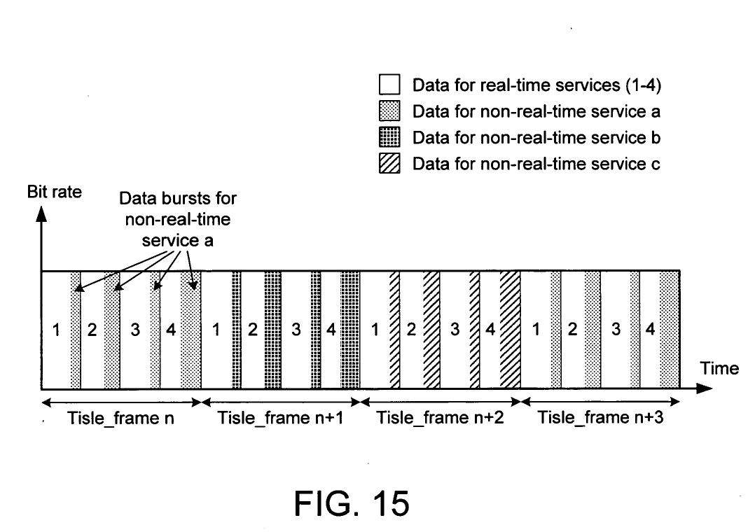

FIG. 15 depicts using non-real-time service data for one service to pad the unused portions of a Tisle frame according to one or more embodiments of the invention. As above, when real-time services are transmitted using fixed-duration bursts, there is almost always unused capacity. This is depicted in the figure by the shaded portions following each of real-time services 1-4. Here, non-real-time services a, b, and c are used to pad the unused capacity of each frame. For each Tisle frame, the padding service is incremented. So for the first frame, service a is used to pad the available capacity in each of the slots. For the second frame, service b is used to do the same.

For purposes of signaling this form of padding, the non-real-time services treat each Tisle frame as if it were a single burst. For example, even if the data for service a appears in four parts inside each of slots 1 through 4, these four parts are considered as one time slicing burst.

Using this form of padding, a substantial amount of data for a particular non-real-time service can be sent in a single frame, even when a particularly small burst size is used (e.g., for DVB-H, the smallest burst size is 512 kbits). It would take longer to deliver the same amount of data for a particular non-real-time service if only one slot per frame contained the service.

The table below compares the parameter values between the real-time and non-real-time services. N is the number of non-real-time services, and K is the number of Tisle slots per Tisle frame:

TABLE 5
Parameter Comparison between Service Types

| Name | Real-time Services | Non-real-time Services |
|---|---|---|
| Tisle Period | Tisle_frame_duration | N * Tisle_frame_duration |
| Max Burst Duration | Tisle_slot_duration | Tisle_frame_duration |
| Min Burst Size | 0 | 0 |
| Max Burst Size | Tisle_slot_size | K * Tisle_slot_size |

One difficulty in creating this form of padding is that an MPE-FEC frame for non-real-time services cannot be filled without knowing how much unused capacity there is from a real-time service frame. This may be overcome by first forming a Tisle frame for real-time services in the Tisle frame generation 904 block within the TS generation and multiplexing 207 block. This frame will have slots which may have unused capacity. The amount of unused capacity in a particular frame is calculated and signaled to the MPE-FEC encoding 213 block in the non-real-time services branch (i.e. “Available Burst Size” signal in FIG. 2). Once known, the MPE-FEC frame being formed in the non-real-time services branch can be sized accordingly and filled with application data and RS data such that the available burst size is not exceeded. The MPE-FEC frame is then forwarded and added in to the slots within the current Tisle frame having unused capacity. The filled Tisle frame can now be forwarded for transmission.

Any of the above methods for filling unused capacity in digital broadcast transmissions may be used alone or in concert with other methods. For example, when multiplexing padding data with real-time service bursts, non-real-time service data may be used as padding rather than the null TS packets discussed. This applies whether the non-real-time service packets are integrated during either the slot formation or the frame formation. Likewise, a transmitter 103 may be able to dynamically modify the method of filling capacity, depending on the nature of the real-time services and non-real-time services it is presently transmitting. For example, when sending larger chunks of data during for a particular non-real-time service, transmitter 103 may opt to integrate the non-real-time service data on a frame-by-frame rather than slot-by-slot basis.

Although time-slicing allows for bursts of varying duration, the concentration above has been on the case where Tisle frames and slots are fixed in duration, and delta-t is constant. If Tisle frame and slot duration as well as delta-t vary from burst to burst, implementing the invention may be more complex. For example, the transmission may need to be buffered for two full frames in order that the next delta-t and burst duration can be calculated. This would cause greater buffer delay for receivers. Nevertheless, this increased complexity of these alternatives should not limit the invention to the case of fixed duration frames and slots and constant delta-t.

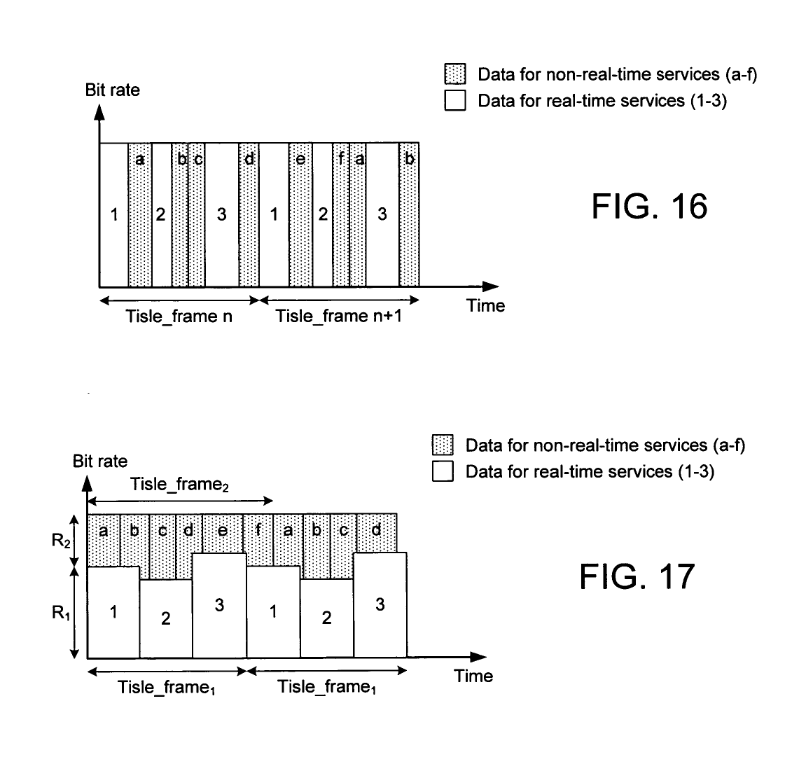

Other alternative methods for transmitting digital content more efficiently are available and within the scope and spirit of the invention. Such alternatives may mix real-time and non-real-time services, as well as mix reserved capacity and variable padded capacity to varying degrees. FIG. 16 depicts using non-real-time service data to pad the unused portions of Tisle slots according to one or more embodiments of the invention. This alternative illustrates the case in which the total maximum bit rate is reserved for real-time services and non-real-time services utilize the padded or excess capacity. FIG. 17 also depicts using non-real-time service data to pad the unused portions of Tisle slots according to one or more embodiments of the invention. This alternative varies the reserved bit rates (R₁ and R₂) for real-time and non-real-time services for each slot. Such an alternative may be useful when bit rates for certain real-time services are constant but different from each other.

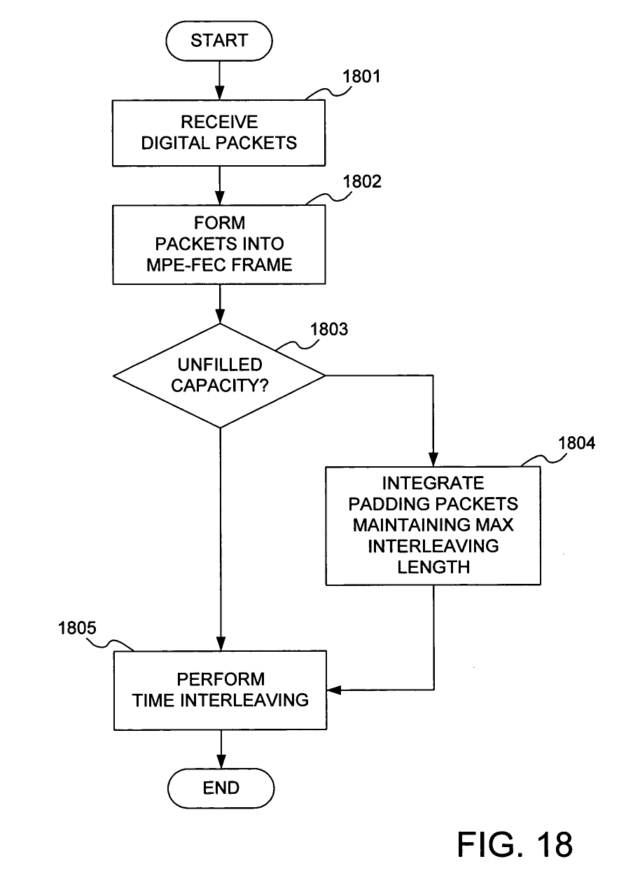

FIG. 18 is a flowchart illustrating a method for maximizing interleaving length for MPE-FEC. At step 1801, a digital broadcast transmitter receives digital packets (e.g., IP packets) for transmission. The packets are formed into a frame for MPE-FEC calculations at step 1802. At decision 1803, if there is unused capacity in the MPE-FEC frame, then at step 1804, padding packets are integrated into the MPE-FEC frame in a fashion which maximizes interleaving length. Padding packets may include empty packets (e.g., null TS packets), or may include packets containing other useful data. These packets may be multiplexed into the MPE-FEC frame in order to ensure maximum interleaving length. At step 1805, the MPE-FEC frame undergoes time-interleaving, and the method is complete.

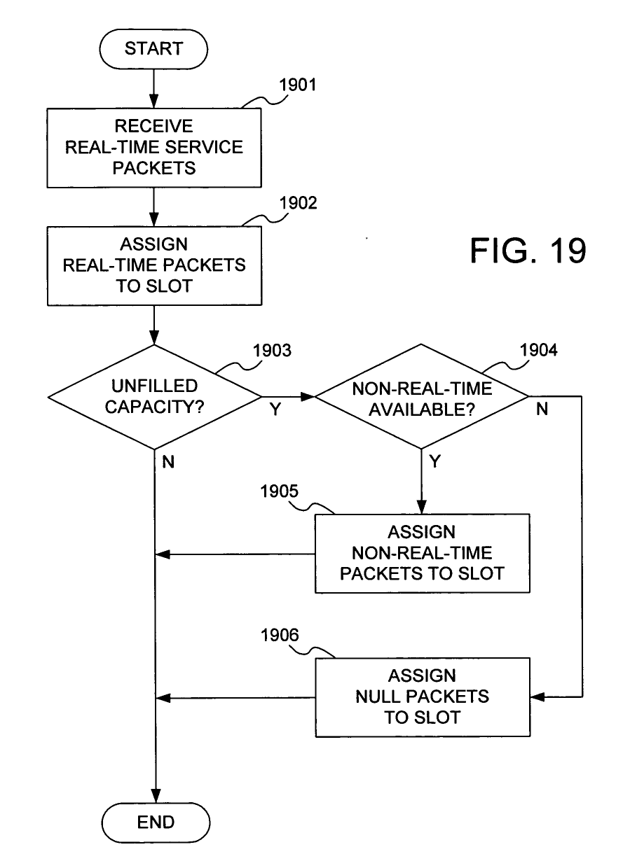

FIG. 19 is a flowchart illustrating a method for padding real-time service Tisle slots with non-real-time service packets. At step 1901, a digital broadcast transmitter receives real-time service packets containing time-sensitive content for transmission (e.g., streaming video or audio). At step 1902, the real-time service content is assigned to a particular Tisle slot for time-sliced transmission. At decision 1903, if there is unfilled capacity in the Tisle slot, then at decision 1904, non-real-time service packets are checked for availability. If available, at step 1905, these packets are used to pad the unfilled capacity and are assigned to the same slot. If non-real-time packets are not available, then at step 1906, null packets are assigned to the remaining unfilled capacity in the Tisle slot.

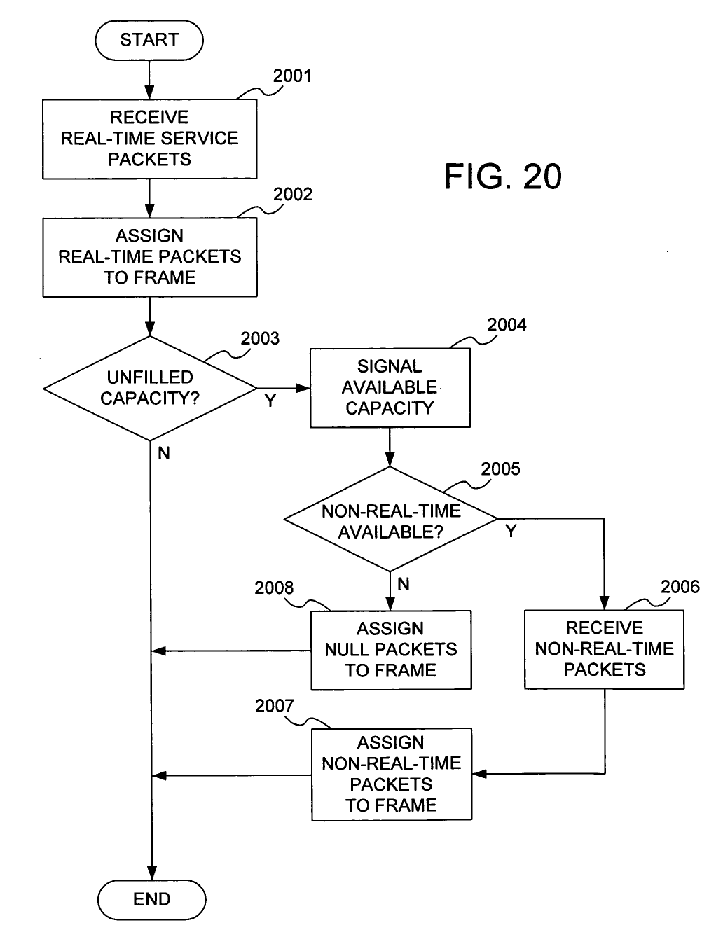

FIG. 20 is a flowchart illustrating a method for padding real-time service Tisle frames with non-real-time service packets. At step 2001, a digital broadcast transmitter receives real-time service packets containing time-sensitive content for transmission (e.g., streaming video or audio). At step 2002, the real-time service content is assigned to various slots within a particular Tisle frame for time-sliced transmission. If, at decision 2003, there is unfilled capacity, then the available capacity is signaled at step 2004. At this point, non-real-time service packets awaiting the signal may be formed into an MPE-FEC frame sized to fit the available capacity. If there are available non-real-time packets at decision 2005, then those packets are received at step 2006, and at step 2007, they are assigned to fill all available capacity within each of the slots within the Tisle frame. The non-real-time packets received may all be parts of the same non-real-time service. Although these non-real-time packets are interspersed among multiple slots, the combination may be viewed as a single burst for purposes of configuration information such as delta-t and burst duration. At step 2008, if no non-real-time packets are available, the remaining capacity within the frame may be padded with empty packets (e.g., null TS packets).

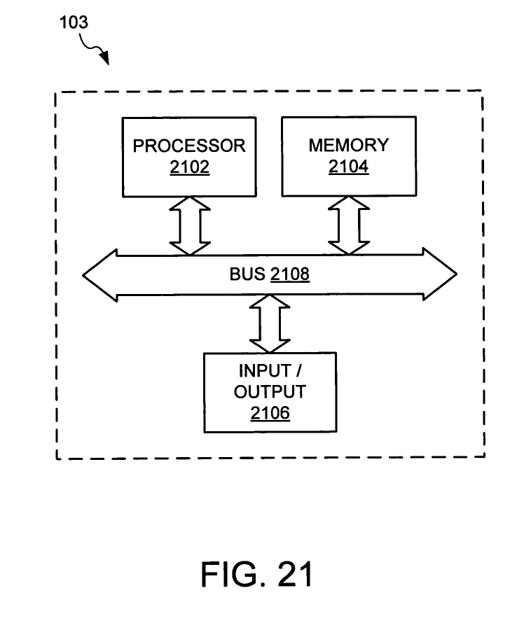

FIG. 21 illustrates a suitable digital broadcast transmitter 103 in which one or more illustrative embodiments of the invention may be implemented. At a minimum, a digital broadband transmitter contains one or more processors 2102, memory 2104 (both volatile and non-volatile) for storing data and processor instructions, input/output 2106 for communicating with peripherals and other computers, and one or more busses 2108 to enable communication between the components. Input/output 2106 block may include one or more network interfaces for communicating with computers over a network connection. Digital broadcast transmitter 103 may include multiple processors distributed among multiple computer servers (not shown). Furthermore, transmitter 103 may further include interfaces to displays, keyboards, mice, and other devices (not shown) enabling human interaction.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A digital broadcast transmitter, comprising:
one or more network interfaces;
one or more processors, configured to perform the steps of:
receiving a plurality of high-priority data packets via the one or more network interfaces, wherein the plurality of high-priority data packets include content for higher priority transmission;
receiving a plurality of lower-priority data packets via the one or more network interfaces, wherein the plurality of lower-priority data packets include content for lower-priority transmission;
forming the plurality of high-priority data packets into a first burst for time-sliced transmission;
determining if additional capacity is available within the first burst;
responsive to additional capacity being available, inserting a first portion of the plurality of lower-priority data packets into the first burst; and
forwarding the first burst for transmission.

2. The digital broadcast transmitter of claim 1, wherein the one or more processors are further configured to perform the steps of:
forming a second portion of the plurality of lower-priority data packets into a second burst for time-sliced transmission; and
forwarding the second burst for transmission.

3. The digital broadcast transmitter of claim 2, wherein the one or more processors are further configured to perform the steps of:
combining the first burst and the second burst for simultaneous transmission.

4. The digital broadcast transmitter of claim 1, wherein the plurality of high-priority data packets include streaming video data.

5. The digital broadcast transmitter of claim 1, wherein the plurality of high-priority data packets and the plurality of lower-priority data packets include Internet Protocol (IP) packets.

6. The digital broadcast transmitter of claim 1, wherein the plurality of high-priority data packets and the plurality of lower-priority data packets are for transmission in a Digital Video Broadcasting—Handheld (DVB-H) system.

7. A method for padding time-slice bursts, the method comprising:
receiving time-sensitive data packets for transmission in a digital broadcast transmission system;
receiving time-insensitive data packets for transmission in the digital broadcast transmission system;
forming the time-sensitive data packets into a first time-slice burst;
determining whether the first time-slice burst has been filled by the time-sensitive data packets;
responsive to the time-sensitive data packets not filling the first time-slice burst, filling any remaining capacity in the first time-slice burst with a first portion of the time-insensitive data packets; and
forwarding the full first time-slice burst for transmission.

8. The method of claim 7, further comprising:
forming a second portion of the time-insensitive data packets into a second time-slice burst; and
forwarding the second time-slice burst for transmission.

9. The method of claim 8, further comprising:
combining the first time-slice burst and second time-slice burst for simultaneous transmission.

10. The method of claim 7, wherein the digital broadcast transmission system is a Digital Video Broadcast—Handheld (DVB-H) system.

11. The method of claim 7, wherein the time-sensitive data packets comprise video data.

12. The method of claim 7, wherein the time-sensitive data packets comprise audio data.

13. The method of claim 6, wherein the time-insensitive data packets comprise a file for download.

14. A digital broadcast transmitter, comprising:
one or more network interfaces, for receiving real-time service packets and non-real-time service packets;
a storage, for storing received real-time service packets; and
a processor, configured to perform the steps of:
receiving real-time service packets via the one or more network interfaces, wherein the real-time service packets include time-sensitive data;
receiving non-real-time service packets via the one or more network interfaces, wherein the non-real-time service packets do not include time-sensitive data;
storing the real-time service packets in the storage;
forming the real-time service packets into a Tisle slot;
determining if additional capacity is available in the Tisle slot;
responsive to additional capacity being available in the Tisle slot, adding non-real-time service packets to the Tisle slot;
forwarding the Tisle slot for transmission.

15. The digital broadcast transmitter of claim 14, wherein the Tisle slot is forwarded for transmission in a Digital Video Broadcasting—Handheld (DVB-H) network.
